(19) United States
(12) Patent Application Publication
(10) Pub. No.: US 2015/0108410 A1
(43) Pub. Date: Apr. 23, 2015

(54) CHITOSAN-BASED BINDER FOR ELECTRODES OF LITHIUM ION BATTERIES

(71) Applicant: Guangzhou Institute of Energy Conversion, Chinese Academy of Sciences, Guangzhou (CN)

(72) Inventors: Lingzhi ZHANG, Guangzhou (CN); Lu YUE, Guangzhou (CN); Haoxiang ZHONG, Guangzhou (CN)

(21) Appl. No.: 14/582,154

(22) Filed: Dec. 23, 2014

Related U.S. Application Data
(63) Continuation-in-part of application No. PCT/CN2013/071317, filed on Feb. 4, 2013.

(30) Foreign Application Priority Data
Jul. 13, 2012 (CN) 201210243617.7

(51) Int. Cl. H01M 4/62; C08L 5/00; H01M 10/0525

(52) U.S. Cl. CPC H01M 4/622; H01M 10/0525; C08L 5/00
USPC 252/500; 106/162.2

(57) ABSTRACT

Binder including (i) a chitosan derivative and (ii) deionized water or 1 vol. % aqueous solution of acetic acid as a dispersant. A method for preparing an electrode of a lithium ion battery by adding the binder to a conductive agent.

### CROSS-REFERENCE TO RELATED APPLICATIONS

This application is a continuation-in-part of International Patent Application No. PCT/CN2013/071317 with an international filing date of Feb. 4, 2013, designating the United States, now pending, and further claims priority benefits to Chinese Patent Application No. 201210243617.7 filed Jul. 13, 2012. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to a binder comprising a chitosan derivative for preparation of electrodes of lithium ion batteries.

2. Description of the Related Art

After high level intercalation and deintercalation of lithium ions, silicon-based electrode materials often suffer from the volume effect, which greatly reduces the cycle performance of the electrodes. Studies show that the selection of the binder of lithium ion batteries is very important for counteracting the volume effect.

Conventional organic binders, e. g., polyvinylidene fluoride (PVDF), tend to absorb the electrolyte and swell, thereby reducing the bond performance of the binders, and the volume of silicon particles often changes in the process of charging and discharging. In addition, PVDF is generally dissolved in the volatile, flammable and explosive N-methyl-2-pyrrolidone (NMP), which poses serious pollution to the environment. Water-based binders have low production costs and are environment friendly, which arouses wide concerns for developing binders for lithium ion batteries. Carboxymethylcellulose sodium (CMC) is a common water-based binder containing hydroxyl groups. The hydroxyl groups cooperate with SiO₂ on the surface of Si to form hydrogen bonds thereby reducing the volume changes of silicon particles, and improving the cycle performance of silicon-based anodes. However, CMC contains limited hydroxyl groups, so that the electrochemical properties of the binder are not ideal. Recently, Alginate with more amounts of carboxyl groups and higher modulus has been reported as a water soluble binder of silicon, and it exhibited better electrochemical properties than that of CMC.

### SUMMARY OF THE INVENTION

It is one objective of the invention to provide a binder for an electrode of lithium ion batteries that has low costs, and is water-soluble and environment-friendly.

It is another objective of the invention to provide an electrode of lithium ion batteries comprising the binder.

To achieve the above objective, in accordance with one embodiment of the invention, there is provided a binder comprising a chitosan derivative represented by formula I or II, the binder employing deionized water or an aqueous solution comprising 1 vol. % of acetic acid as a dispersant;

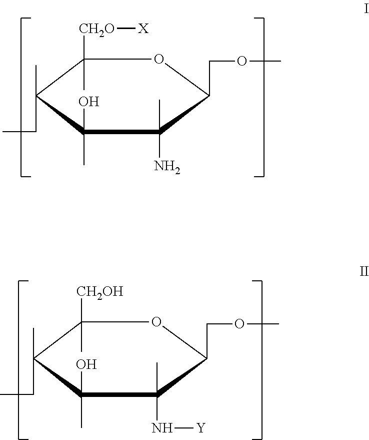

wherein, X of the formula I represents a hydrocarbon acyl, aromatic acyl, alkyl, or aryl, and Y of the formula II represents an alkane acyl or aryl.

The raw material of the binder is originated from chitin. Chitin is extracted from crustacean such as shrimp shells and crab shells, so it has a broad source, low costs, and is free of pollution. Chitin is deacetylated to yield chitosan, which can be used for preparation of carboxylation chitosan (C-chitosan), chitosan lactate, and so on.

The invention also provides a method for preparing an electrode of a lithium ion battery, the method comprising adding the binder in the process of preparation.

In a class of this embodiment, the chitosan derivative represented by formula I or II has a viscosity of between 50 and 1000 cps. Chitosan is difficult to dissolve in pure water. To improve the dissolubility, a small amount of weak acid is employed, for example, an aqueous solution comprising 1 vol. % of acetic acid is added to dissolve chitosan. Acetic acid is volatile quickly upon heating and no residue stays in the electrode, thereby having no influence on the properties of the electrode. Chitosan derivatives are water-soluble, so deionized water can be used as a solvent thereof.

In general, for preparing an electrode of a lithium ion battery, the binder is firstly prepared into a solution comprising 1-5 wt. % of the chitosan derivative, during which, deionized water is added as a diluent to regulate the denseness of the slurry. The electrode of the lithium ion battery comprises an active material, a conductive agent, and the binder, a mass percent thereof being 50-80:10-30:5-20. The anode electrode active material of the lithium ion battery comprises silicon-based anode electrodes, graphite-based anode electrodes, lithium titanate, metal oxides, and sulfides. The cathode electrode active material comprises lithium iron phosphate, lithium cobalt oxide, ternary materials, and binary materials rich in lithium-manganese or nickel-manganese. The conductive agent is acetylene black or super conductive carbon black. In preparation, the mixing time of the slurry exceeds 20 min, the coating membrane has a thickness of between 100 and 300 μm, and the drying temperature of the membrane is between 60 and 90° C.

Advantages of the invention are as follows: the raw materials of the binder are water-soluble, environment friendly, and have a broad source. The electrode prepared using the binder has improved cycle performance, and causes no pollution to environment.

### BRIEF DESCRIPTION OF THE DRAWINGS

FIG. 1A shows the cycle performance of a silicon-based electrode prepared in examples and comparison examples of the invention at the charge-discharge current density of 200 mA/g;

FIG. 1B shows the cycle performance of a SnS₂ electrode prepared in examples and comparison examples of the invention at the charge-discharge current density of 322 mA/g;

FIG. 1C shows the cycle performance of a LiNi_{1/3}CO_{1/3}Mn_{1/3}O₂ cathode electrode prepared in examples and comparison examples of the invention at the charge-discharge current density of 27.7 mA/g;

FIG. 1D shows the cycle performance of a LFP cathode electrode prepared in examples and comparison examples of the invention with carboxylation chitosan/SBR as a binder at the charge-discharge current density of 0.2 C;

FIG. 1E shows the cycle performance of a ternary (NCM) cathode electrode prepared in examples and comparison examples of the invention with carboxylation chitosan/PEO as a binder at the charge-discharge current density of 0.2 C;

FIG. 1F shows the cycle performance of a LFP cathode electrode (capacity of 10 Ah) prepared in examples and comparison examples of the invention with carboxylation chitosan as a binder at the charge-discharge current density of 1 C;

FIG. 2A shows the cycle performance of a silicon-based electrode prepared in examples and comparison examples of the invention at the charge-discharge current density of 1000 mA/g;

FIG. 2B shows the cycle performance of a SnS₂ electrode prepared in examples and comparison examples of the invention at different charge-discharge current densities;

FIG. 2C shows the cycle performance of a LFP electrode prepared in examples and comparison examples of the invention at different current densities;

FIG. 2D shows the cycle performance of a NCM electrode prepared in examples and comparison examples of the invention at different current densities;

FIG. 3A is Nyquist diagrams of AC impedance tests of a silicon-based electrode prepared in examples and comparison examples of the invention after 2 cycles;

FIG. 3B is Nyquist diagrams of AC impedance tests of a silicon-based electrode prepared in examples and comparison examples of the invention after 40 cycles;

FIG. 3C is Nyquist diagrams of AC impedance tests of a SnS₂ electrode prepared in examples and comparison examples of the invention after 2 cycles;

FIG. 3D is Nyquist diagrams of AC impedance tests of a LFP electrode prepared in examples and comparison examples of the invention after 3 cycles;

FIG. 4A is a SEM image of silicon;

FIG. 4B is a TEM image of silicon;

FIG. 4C is a SEM image of a silicon-based electrode;

FIG. 4D is a SEM image of an electrode with PVDF as a binder after 40 cycles;

FIG. 4E is a SEM image of an electrode with CMC as a binder after 40 cycles;

FIG. 4F is a SEM image of an electrode with chitosan having a viscosity of 300 cps (mPa·s) as a binder after 40 cycles;

FIG. 4G is a SEM image of electrodes with chitosan lactate as a binder after 40 cycles; and

FIG. 4H is a SEM image of electrodes with carboxylation chitosan as a binder after 40 cycles.

### DETAILED DESCRIPTION OF THE EMBODIMENTS

For further illustrating the invention, experiments detailing a binder for an electrode of lithium ion batteries are described below. It should be noted that the following examples are intended to describe and not to limit the invention.

An electrode of a lithium ion battery is prepared as follows:

1) preparing an aqueous solution comprising 1-5 wt. % of a chitosan derivative represented by formula I or II, to yield a binder;

2) grinding nano-silicon and acetylene black in a mortar for 5-10 min;

3) adding dropwise the binder in 1) to the mixture in 2), a mass ratio of the binder to the mixture being between 1:9 and 1:4, and uniformly grinding;

4) adding deionized water to the mixture obtained in 3), and grinding for 10-15 min;

5) uniformly coating the mixture obtained in 4) on a copper sheet;

6) drying the copper sheet in 5) for removal of a solvent to yield an electrode plate, vacuum drying the electrode plate, cutting and weighing the electrode plate to assembly batteries.

### Example 1

Prepare an aqueous solution comprising 1-5 wt. % of chitosan having a viscosity of 90 cps (mPa·s) and 1 vol. % of acetic acid, to yield a binder. 80 mg of nano-silicon and 38.7 mg of acetylene black were ground in a mortar for 10 min, and then 0.2064 g of the binder comprising 5 wt. % of chitosan were added dropwise. The mixture was ground for 5 min to enable the binder to be uniformly mixed with the silicon powder and the carbon powder. Thereafter, 1 mL of deionized water was added and ground for another 10-15 min The resulting pasty mixture was uniformly coated on a copper sheet using a 100 μm scraper, and dried in an air dry oven at 70° C. for 5 min. The resulting electrode plate was dried in a vacuum drying oven for 6 hours at 90° C. The electrode plate was cut and weighed, and assembled in a No. 2025 battery case in a glove box. Take lithium sheet as a counter electrode, polyethylene membrane as a separator, and 1 M LiPF₆ EC/DMC/DEC (v/v/v=1/1) as an electrolyte, to assemble a lithium ion battery. The charge-discharge tests of the lithium ion battery were carried out under constant current.

### Example 2

The preparation method is the same as that in Example 1 except that chitosan having a viscosity of 300 cps was employed.

### Example 3

The preparation method is the same as that in Example 1 except that chitosan having a viscosity of 650 cps was employed.

### Example 4

The preparation method is the same as that in Example 1 except that carboxylation chitosan represented by formula III having a viscosity of 90 cps was employed.

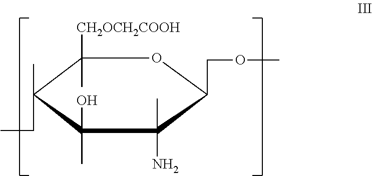

### Example 5

The preparation method is the same as that in Example 1 except that a chitosan lactate represented by formula IV having a viscosity of 90 cps was employed.

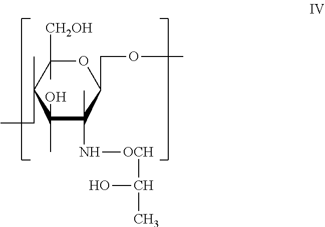

### Example 6

Prepare an aqueous solution comprising 3.5 wt. % of chitosan having a viscosity of 90 cps and 1 vol. % of acetic acid, to yield a binder. 70 mg of nano-SnS₂ and 20 mg of acetylene black were ground in a mortar for 10 min, and then 0.2876 g of the binder comprising 3.5 wt. % of chitosan were added dropwise. The mixture was ground for 5 min to enable the binder to be uniformly mixed. Thereafter, 1 mL of deionized water was added and ground for another 10-15 min The resulting pasty mixture was uniformly coated on a copper sheet using a 100 μm scraper, and dried in an air dry oven at 70° C. for 5 min. The resulting electrode plate was dried in a vacuum drying oven for 6 hours at 90° C. The electrode plate was cut and weighed, and assembled in a No. 2025 battery case in a glove box. Take lithium sheet as a counter electrode, polyethylene membrane as a separator, and 1 M LiPF₆ EC/DEC (v/v=1/1) as an electrolyte, to assemble a lithium ion battery. The charge-discharge tests of the lithium ion battery were carried out under constant current.

### Example 7

Prepare an aqueous solution comprising 3.5 wt. % of carboxylated chitosan to yield a binder. 200 mg of LiNi_{1/3}Co_{1/3}Mn_{1/3}O₂ and 25 mg of acetylene black were ground in a mortar for 10 min, and then 0.2083 g of the binder comprising 3.5 wt. % of carboxylated chitosan were added dropwise. The mixture was ground for 5 min to enable the binder to be uniformly mixed. Thereafter, 0.5 mL of deionized water was added and ground for another 10-15 min. The resulting pasty mixture was uniformly coated on an Al sheet using a 100 μm scraper, and dried in an air dry oven at 70° C. for one hour. The resulting electrode plate was dried in a vacuum drying oven for 6 hours at 90° C. The electrode plate was cut and weighed, and assembled in a No. 2025 battery case in a glove box. Take lithium sheet as a counter electrode, polyethylene membrane as a separator, and LiPF₆ EC/DMC/DEC (v/v/v=1/1) as an electrolyte, to assemble a lithium ion battery. The charge-discharge tests of the lithium ion battery were carried out under constant current.

### Example 8

Prepare an aqueous solution comprising 3.5 wt. % of carboxylated chitosan to yield a binder. 0.9 g of lithium iron phosphate (LFP) and 0.1 g of acetylene black were ground in a mortar for 10 min, and then 1.71 g of the binder comprising 3.5 wt. % of chitosan were added dropwise. The mixture was ground for 5 min to enable the binder to be uniformly mixed. 0.8 g of 5% styrene butadiene rubber (SBR) solution was added and ground for 5 min. Thereafter, 1 mL of deionized water was added and ground for another 10-15 min. The resulting pasty mixture was uniformly coated on an Al sheet using a 200 μm scraper, and dried in an air dry oven at 70° C. for 5 min. The resulting electrode plate was dried in a vacuum drying oven for 6 hours at 90° C. The electrode plate was cut and weighed, and assembled in a No. 2025 battery case in a glove box. Take lithium sheet as a counter electrode, polyethylene membrane as a separator, and 1 M LiPF₆ EC/DEC (v/v=1/1) as an electrolyte, to assemble a lithium ion battery. The charge-discharge tests of the lithium ion battery were carried out under constant current.

### Example 9

Prepare an aqueous solution comprising 3.5 wt. % of carboxylated chitosan to yield a binder. 0.9 g of a cathode material LiNi_{1/3}Co_{1/3}Mn_{1/3}O₂ (NCM) and 0.1 g of acetylene black were ground in a mortar for 10 min, and then 2.28 g of the binder comprising 3.5 wt. % of carboxylated chitosan were added dropwise. The mixture was ground for 5 min to enable the binder to be uniformly mixed. 0.4 g of 5% PEO aqueous solution was added and ground for 5 min. Thereafter, 1 mL of deionized water was added and ground for another 10-15 min The resulting pasty mixture was uniformly coated on an Al foil using a 200 μm scraper, and dried in an air dry oven at 70° C. for 5 min. The resulting electrode plate was dried in a vacuum drying oven for 6 hours at 90° C. The electrode plate was cut and weighed, and assembled in a No. 2025 battery case in a glove box. Take lithium sheet as a counter electrode, polyethylene membrane as a separator, and 1 M LiPF₆ EC/DEC (v/v=1/1) as an electrolyte, to assemble a lithium ion battery. The charge-discharge tests of the lithium ion battery were carried out under constant current.

### Example 10

Prepare an aqueous solution comprising 3.5 wt. % of carboxylated chitosan to yield a binder. 3.5 kg of deionized water was added to an agitating vessel, and the binder comprising 170 g of the carboxylated chitosan was added to the vessel. The mixture was agitated at low speed for 20 min and at high speed for 30 min to yield a transparent and clear colloid. 85 g of superP was added, agitated at low speed for 10 min and at high speed for 90 min to yield a sticky paste. 4 kg of lithium iron phosphate was added, agitated at low speed for 20 min and at high speed for 90 min to yield slurry. The slurry was coated on an electrode which was dried in a vacuum drying oven for 85 hours at 90° C. The dried pole sheet was assembled in a square battery having capacity of 10 Ah. The charge-discharge tests of the battery were carried out under constant current.

### Comparison example 1

The preparation method is the same as that in Example 1 except that PVDF is used as a binder, N-methyl pyrrolidone (NMP) is used as a solvent, and the drying temperature of the membrane (electrode plate) is 120° C. (vacuum drying).

### Comparison example 2

The preparation method is the same as that in Example 1 except that CMC having a viscosity of 900-1200 cps is used as a binder, deionized water is used as a solvent, and the drying temperature of the membrane (electrode plate) is 90° C. (vacuum drying).

The following descriptions detail the electrochemical properties and structural changes of an electrode a lithium ion battery prepared by the chitosan binder of the invention based on charge-discharge cycle performance tests, electrochemical impedance spectroscopy, and SEM images.

1. Cycle Performance Tests

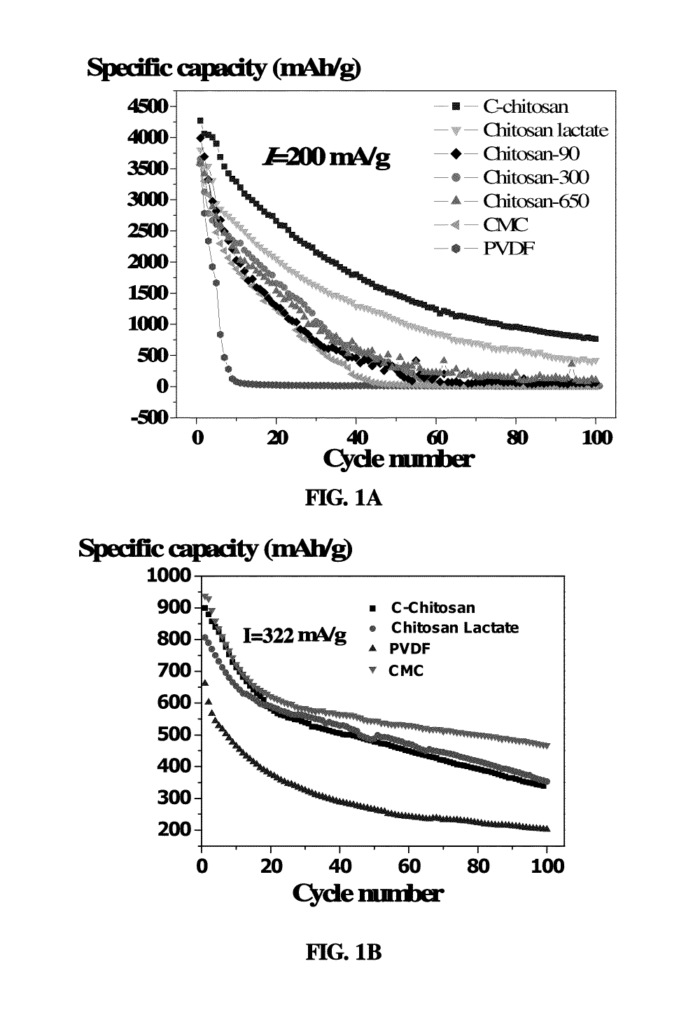

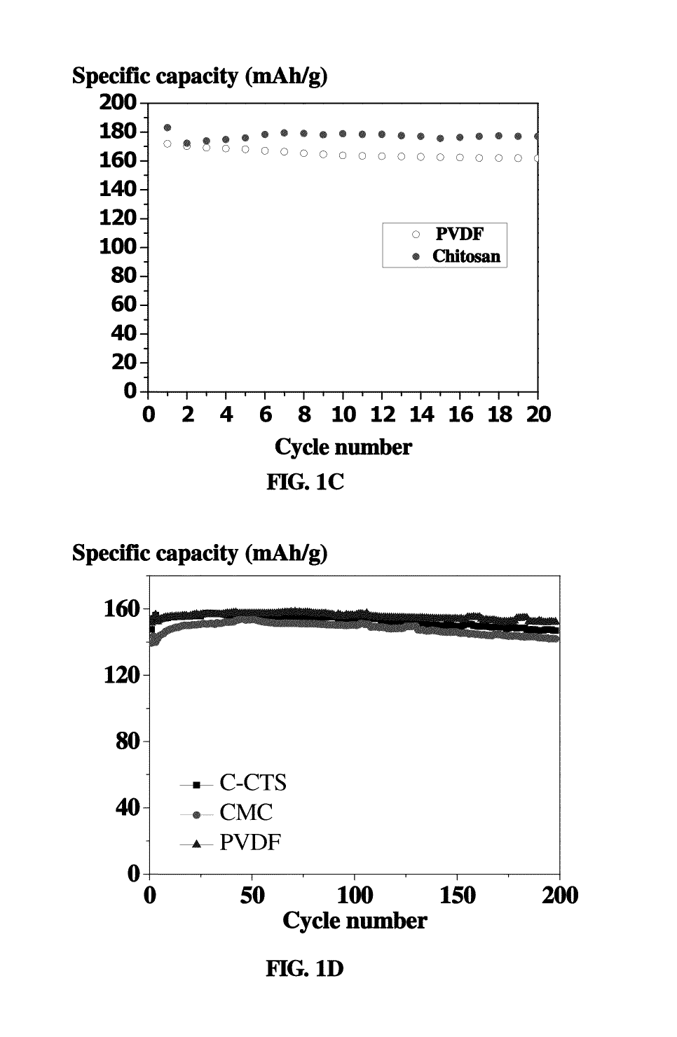

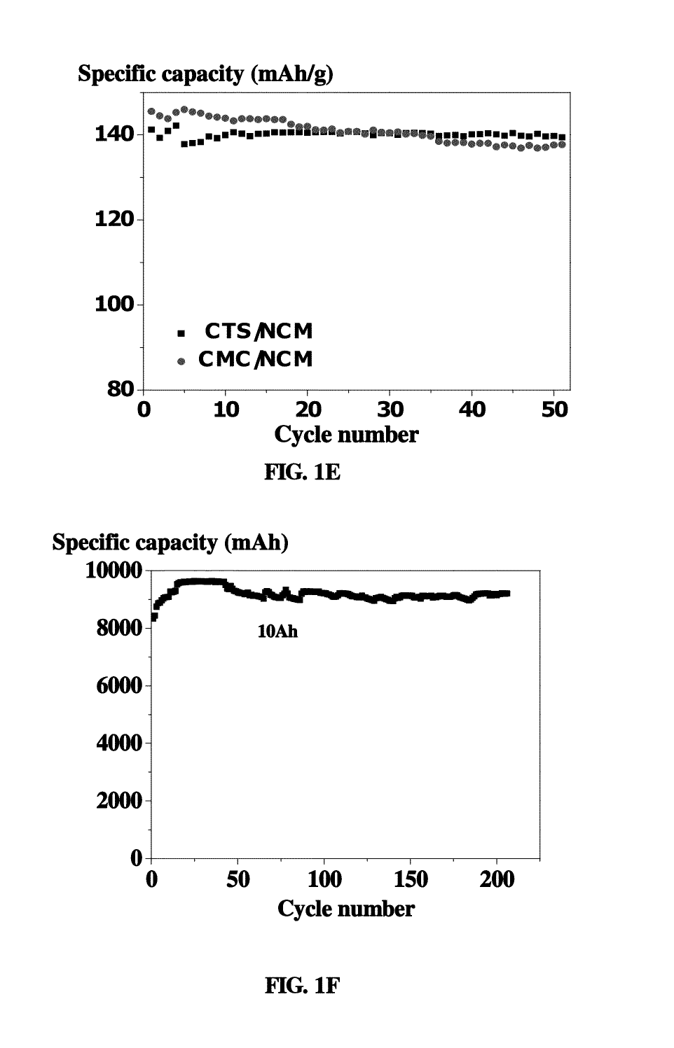

FIG. 1A shows the cycle performance of a silicon-based electrode prepared in examples and comparison examples of the invention at the charge-discharge current density of 200 mA/g. Table 1 lists the charge-discharge specific capacity and efficiency of silicon-based electrodes.

TABLE 1
Charge-discharge specific capacity and
efficiency of Si-based electrodes

| | First | First | | 50^{th} | 100^{th} |
|---|---|---|---|---|---|
| | discharge | charge | | discharge | discharge |
| | specific | specific | First | specific | specific |
| | capacity | capacity | coulomb | capacity | capacity |
| Binders | (mAh/g) | (mAh/g) | efficiency | (mAh/g) | (mAh/g) |
| PVDF | 3579 | 2551 | 71.3% | 12 | 8 |
| CMC | 3570 | 3173 | 88.9% | 33 | 6 |
| Chitosan-90 | 3991 | 3524 | 88.3% | 271 | 57 |
| Chitosan-300 | 3652 | 3235 | 88.6% | 308 | 7.1 |
| Chitosan-650 | 3577 | 3140 | 87.8% | 293 | 1.3 |
| C-chitosan | 4270 | 3813 | 89.3% | 1478 | 766 |
| Chitosan | 3803 | 3331 | 87.6% | 1076 | 423 |
| lactate | | | | | |

As shown in Table 1, with carboxylated chitosan as a binder, the first discharge specific capacity of the silicon-based electrode reaches up to 4270 mAh/g, which is basically equivalent to the theoretical specific capacity of silicon, that is, 4200 mAh/g. With PVDF as a binder, the first coulomb efficiency is merely 71.3%. With CMC or chitosan as a binder, the first coulomb efficiency exceeds 87%. At the fiftieth cycle, the discharge specific capacity of the electrode employing PVDF as a binder is merely 12 mAh/g, the discharge specific capacity of the electrode employing CMC as a binder is 33 mAh/g. However, the discharge specific capacity of the electrode employing chitosan as a binder is better. Specifically, for chitosan having a viscosity of 90 cps, the discharge specific capacity is 271 mAh/g; for chitosan having a viscosity of 300 cps, the discharge specific capacity is 308 mAh/g; for chitosan having a viscosity of 650 cps, the discharge specific capacity is 293 mAh/g; for chitosan lactate, the discharge specific capacity is 1076 mAh/g; and for carboxylation chitosan, the discharge specific capacity is 1478 mAh/g. The cycle performances of the electrodes with chitosan lactate and carboxylation as a binder present the best, for example, after 100 cycles, the discharge specific capacity can reach 423 mAh/g and 766 mAh/g, respectively.

FIG. 1B shows the cycle performance of a SnS₂ electrode prepared in examples and comparison examples of the invention at the charge-discharge current density of 322 mA/g. Table 2 shows the charge-discharge specific capacity and efficiency of SnS₂ electrodes.

TABLE 2
Charge-discharge specific capacity
and efficiency of SnS₂ electrodes

| | First | First | | 50^{th} | 100^{th} |
|---|---|---|---|---|---|
| | discharge | charge | | discharge | discharge |
| | specific | specific | First | specific | specific |
| | capacity | capacity | coulomb | capacity | capacity |
| Binders | (mAh/g) | (mAh/g) | efficiency | (mAh/g) | (mAh/g) |
| CMC | 936.0 | 581.3 | 62.1% | 544.3 | 467.2 |
| C-chitosan | 837.3 | 510.8 | 61.0% | 482.2 | 339.3 |
| Chitosan | 768.2 | 467.1 | 60.8% | 485.6 | 356.0 |
| lactate | | | | | |
| PVDF | 661.8 | 314.4 | 47.5% | 264.5 | 201.9 |

As shown in Table 2, with carboxylated chitosan as a binder, the first discharge specific capacity of the SnS₂ electrode reaches up to 837.3 mAh/g. With PVDF as a binder, the first coulomb efficiency is merely 47.5%. With CMC or chitosan as a binder, the first coulomb efficiency exceeds 60%. At the fiftieth cycle, the discharge specific capacity of the electrode employing PVDF as a binder is merely 264.5 mAh/g, the discharge specific capacity of the electrode employing CMC as a binder is 544.3 mAh/g. However, the discharge specific capacity of the electrode employing chitosan-based binder is better. Specifically, for chitosan, the discharge specific capacity is 482.2 mAh/g; for chitosan lactate, the discharge specific capacity is 485.6 mAh/g.

FIG. 1C shows the cycle performance of a LiNi_{1/3}Co_{1/3}Mn_{1/3}O₂ cathode electrode prepared in examples and comparison examples of the invention at the charge-discharge current density of 27.7 mA/g. With PVDF as a binder, the first discharge specific capacity of the cathode electrode reaches 173.9 mAh/g. With carboxylated chitosan as a binder, the first charge specific capacity of the cathode electrode reaches 183 mAh/g.

FIG. 1D shows the cycle performance of a LFP cathode electrode prepared in examples and comparison examples of the invention with carboxylated chitosan/SBR as a binder at the charge-discharge current density of 0.2 C. After 200 cycles, the discharge capacities of the electrodes with chitosan (CCTS), PVDE, and CMC as binders are 147 mAh/g, 152 mAh/g, and 142 mAh/g, respectively. In summary, the cycle performances of LFP batteries with CCTS and PVDF as binders are alike, and both are better than batteries with CMC as a binder.

FIG. 1E shows the cycle performance of a ternary (NCM) cathode electrode prepared in examples and comparison examples of the invention with carboxylated chitosan/PEO and CMC as a binder at the charge-discharge current density of 0.2 C. After 50 cycles, the cycle performances of the two batteries presents different. Specifically, the first specific capacity of the CMC battery is 145.5 mAh/g, which is slightly higher than that of the CCTS battery, which is 141.2 mAh/g. However, the CMC battery has much faster attenuation, for example, after 50 cycles, the specific capacity is only 137.7 mAh/g, with an average specific capacity attenuation of 0.11%. In contrast, the CCTS battery has an attenuation of only 0.02%/cycle. At 32th cycle, the discharge specific capacity of the CCTS battery overpasses that of the CMC battery, and basically maintains the same within 50 cycles.

FIG. 1F shows the cycle performance of a LFP cathode electrode (capacity of 10 Ah) prepared in examples and comparison examples of the invention with carboxylation chitosan as a binder at the charge-discharge current density of 1 C. After 200 cycles, the specific capacity shows no significant attenuation.

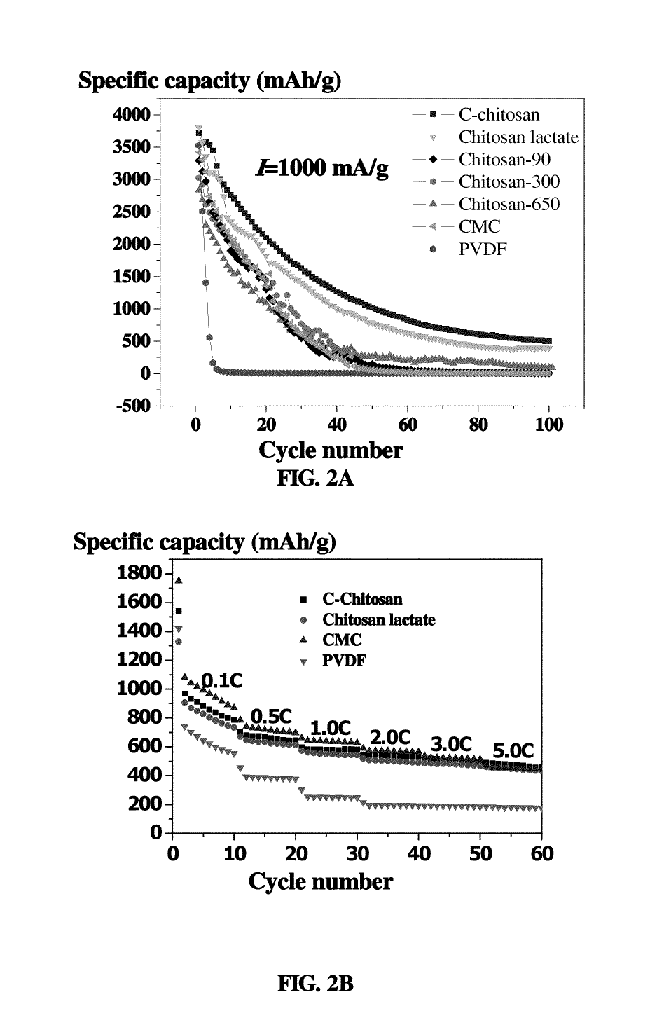

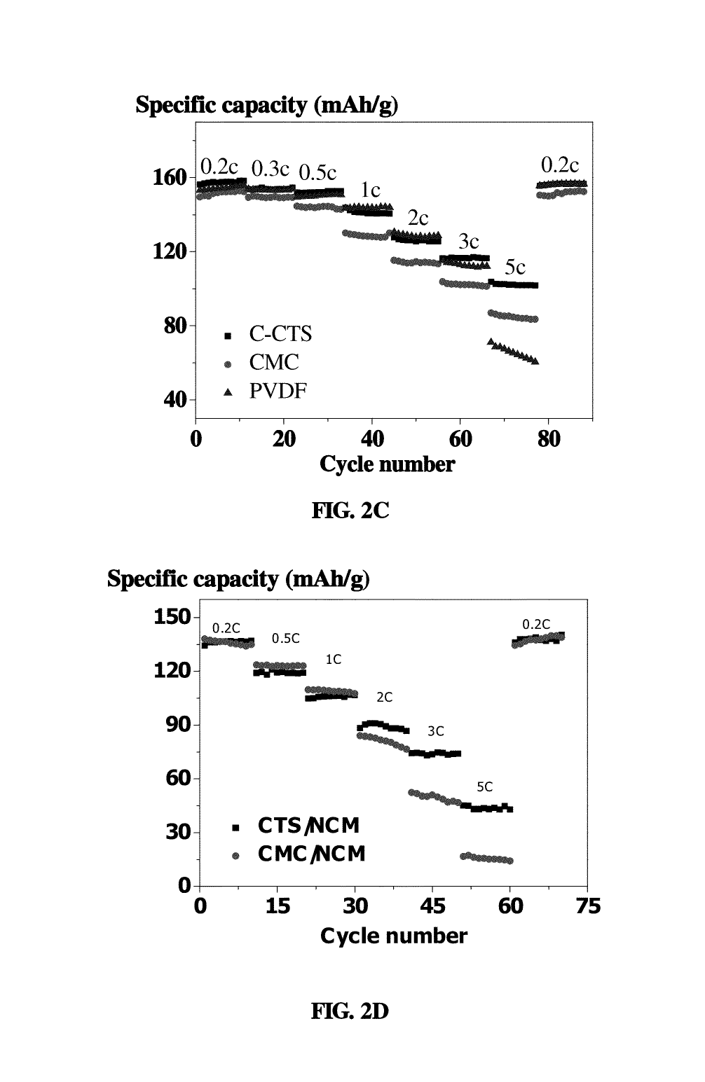

FIG. 2A shows the cycle performance of a silicon-based electrode prepared in examples and comparison examples of the invention at the charge-discharge current density of 1000 mA/g. Table 3 lists the charge-discharge specific capacity and efficiency of silicon-based electrodes.

TABLE 3
Charge-discharge specific capacity and
efficiency of Si-based electrodes

| | First | First | | 50^{th} | 100^{th} |
|---|---|---|---|---|---|
| | discharge | charge | | discharge | discharge |
| | specific | specific | First | specific | specific |
| | capacity | capacity | coulomb | capacity | capacity |
| Binders | (mAh/g) | (mAh/g) | efficiency | (mAh/g) | mAh/g) |
| PVDF | 3529 | 2413 | 68.4% | 3 | 2 |
| CMC | 3422 | 3059 | 89.4% | 55 | 3.6 |
| Chitosan-90 | 3291 | 2843 | 86.4% | 147 | 7.4 |
| Chitosan-300 | 3025 | 2649 | 87.6% | 75 | 4 |
| Chitosan-650 | 2834 | 2488 | 87.8% | 256 | 90 |
| C-chitosan | 3803 | 3396 | 89.3% | 1018 | 498 |
| Chitosan | 3715 | 3243 | 87.3% | 787 | 393 |
| lactate | | | | | |

FIG. 2B shows the cycle performance of a SnS₂ electrode prepared in examples and comparison examples of the invention at different charge-discharge current densities. As shown in the figure, at different charge-discharge current densities, the electrodes prepared by carboxylation chitosan binders and CMC binders present superior performance in contrast to PVDF. At the discharge density of 5 C, the discharge specific capacity of the carboxylation chitosan electrode can reach 480 mAh/g, the discharge specific capacity of the chitosan lactate electrode can reach 455 mAh/g, the discharge specific capacity of the CMC electrode can reach 440 mAh/g, and the discharge specific capacity of the PVDF electrode is only 175 mAh/g. Thus, the SnS₂ electrode with carboxylation chitosan as a binder has good rate capability.

FIG. 2C shows the cycle performance of a LFP electrode prepared in examples and comparison examples of the invention at different current densities. It is known that, the CCTS battery has a specific capacity of 155.5 mAh/g at 0.2 C and 116.5 mAh/g at 3 C, which shows that, the specific capacity at 3 C maintains 74.9% of the specific capacity at 0.2 C. In contrast, the specific capacity of CMC battery and PVDF battery at 3 C only maintains 68.45 and 73.4% of the specific capacity at 0.2 C, respectively. At the discharge-charge density of 5 C, the discharge specific capacity of the CCTS battery maintains 65% of the discharge specific capacity at 0.2 C, which is much higher than 55.9% to CMC battery and 39.4% to PVDF battery. After the high current density tests, the three batteries are tested again at the discharge-charge current density of 0.2 C, and the output specific capacity of the CCTS/CMC/PVDF batteries are 155.6 mAh/g, 150.4 mAh/g, and 155.6 mAh/g, respectively. That is to say, the batteries have good recovery performance.

FIG. 2D shows the cycle performance of a NCM electrode prepared in examples and comparison examples of the invention at different current densities. It is shown that, a NCM battery with CCTS as a binder has better rate performance than a NCM battery with CMC as a binder.

2. AC Impedance Test

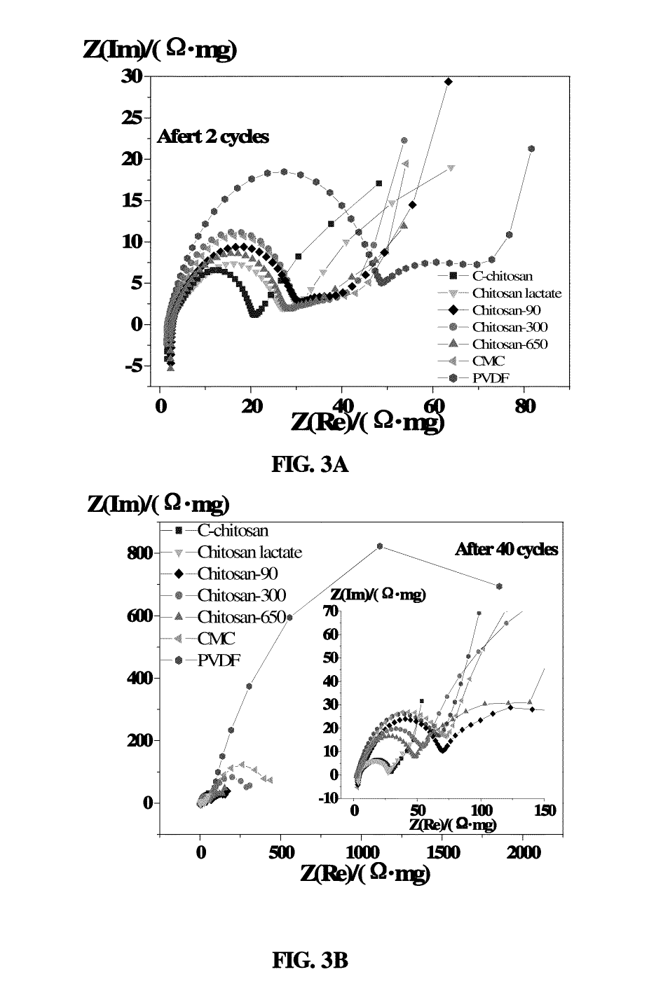

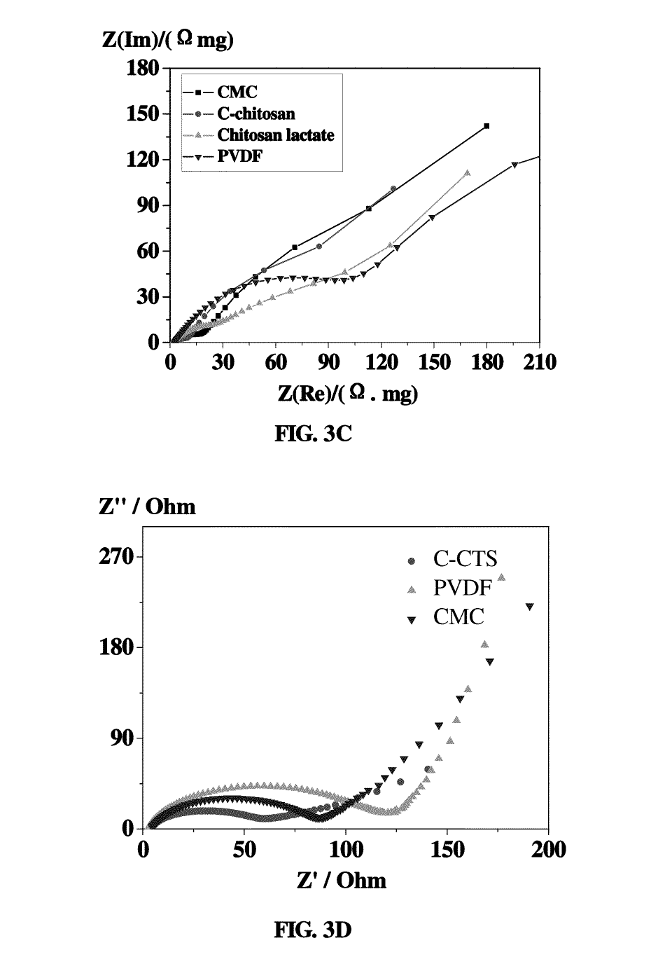

FIG. 3A and 3B are Nyquist diagrams of AC impedance tests of a silicon-based electrode prepared in examples and comparison examples of the invention after 2 cycles and 40 cycles, respectively. In the impedance curves, the arc in the high-frequency area is corresponding to the charge transfer resistance, and the diameter length thereof represents the resistance value. Compare the arc radiuses of different binders in the high-frequency area, it can be known that the charge transfer resistance is the biggest in the PVDF electrode after 2 cycles, and the charge transfer resistance is the smallest in the carboxylation chitosan electrode. The charge transfer resistances of other chitosan electrode are basically the same as that of CMC electrode. After 40 cycles, the charge transfer resistance of PVDF varies greatly, followed by CMC electrode, and the charge transfer resistances of the carboxylation chitosan electrode and chitosan lactate electrode have no obvious changes.

FIG. 3C is Nyquist diagrams of AC impedance tests of a SnS₂ electrode prepared in examples and comparison examples of the invention after 2 cycles. It can be known that the charge transfer resistance is the biggest in the PVDF electrode after 2 cycles, and the charge transfer resistances of chitosan electrodes are basically the same as that of CMC electrode, but are far smaller than the PVDF electrode.

FIG. 3D is Nyquist diagrams of AC impedance tests of a LFP electrode prepared in examples and comparison examples of the invention after 3 cycles. In contrast to CMC and PVDF electrodes, the LFP battery with CCTS as the binder has a relatively small diameter in the high and medium frequency area, which shows that the LFP battery with CCTS as the binder has smaller resistance in contrast to the CMC and PVDF batteries.

3. Electron Microscope Analysis

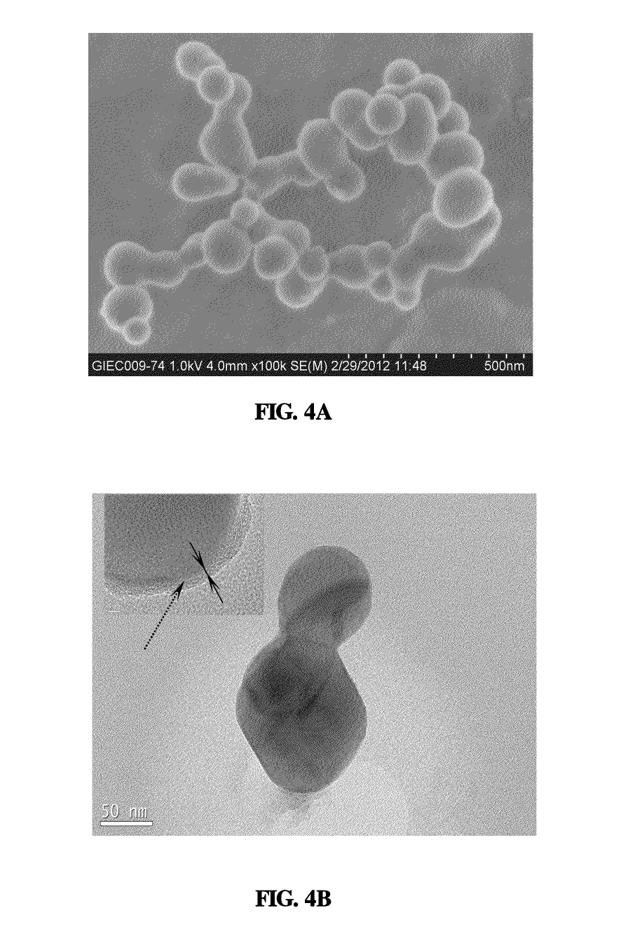

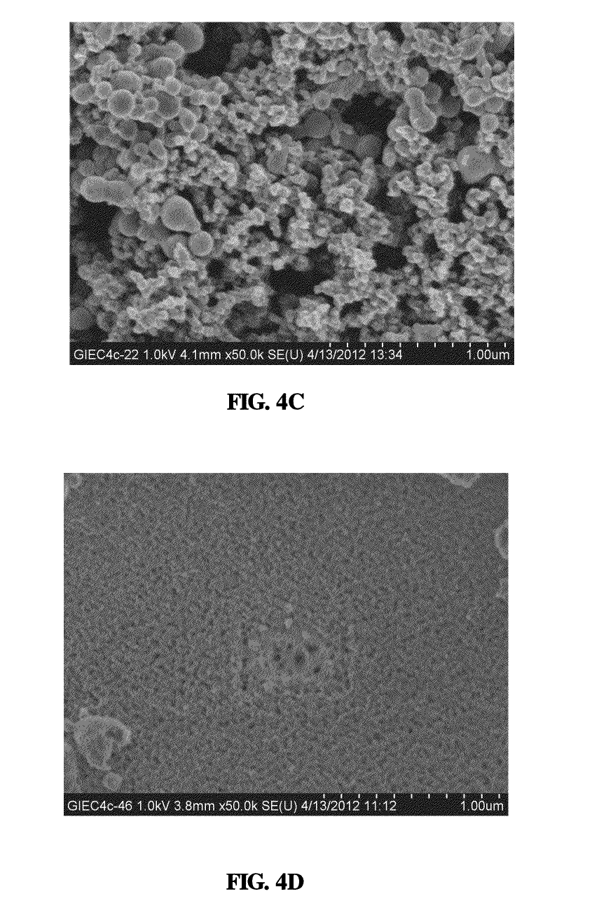

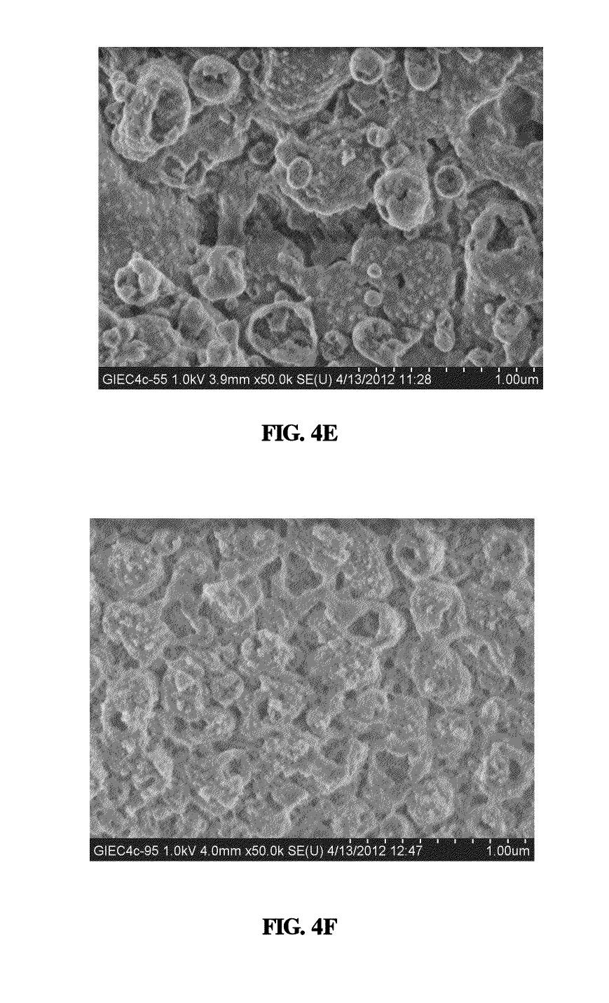

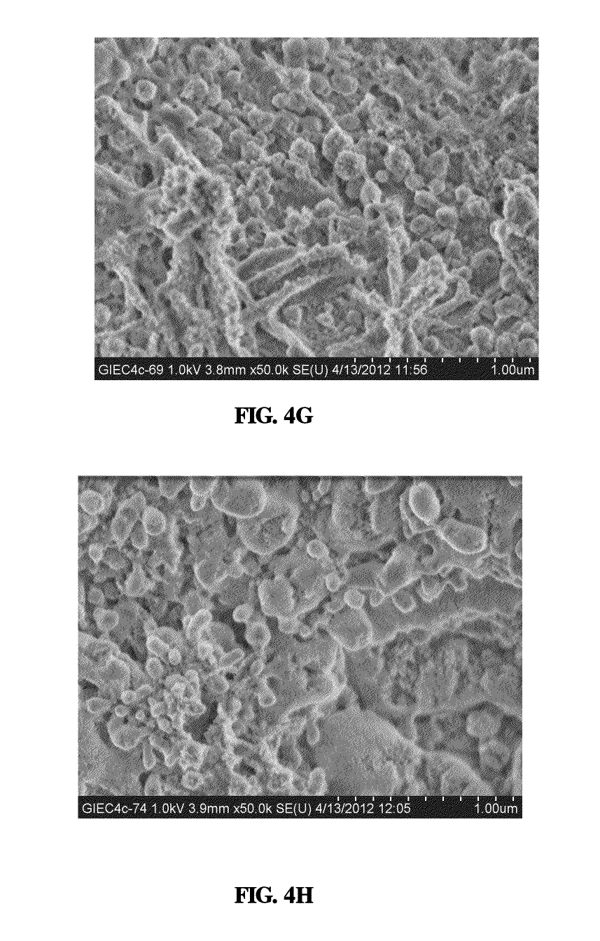

FIG. 4 shows SEM and TEM images of silicon of examples and comparison examples of the invention. FIGS. 4A and 4B are SEM and TEM images of silicon, from which it can be seen that silicon particles are spherical, have particle sizes of 90-150 nm, and the surface thereof is coated with a silica layer having a thickness of 5 nm FIG. 4C is a SEM image of silicon prior to the cycle performance test, from which it can be seen that silicon particles and acetylene black particles are uniformly mixed. FIG. 4D is a SEM image of an electrode with PVDF as a binder after 40 cycles, from which the electrode material is hardly seen, the volume of silicon particles expands greatly in the process of charge and discharge, and the silicon particles detach from the electrode. FIG. 4E is a SEM image of an electrode with CMC as a binder after 40 cycles, from which some big particles and shell-like substances are seen, which are residues of broken silicon particles in the process of charge and discharge. FIG. 4F is a SEM image of an electrode with chitosan having a viscosity of 300 pcs as a binder after 40 cycles, which is basically the same as that in the CMC electrode. FIGS. 4G and 4H are SEM images of electrodes with chitosan lactate and carboxylation chitosan having a viscosity of 300 cps as a binder respectively after 40 cycles, from which it can be seen that the nano-silicon basically remains the original physical appearance after cycles, and the volume expansion of the silicon particles is effectively inhibited.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A binder comprising a chitosan derivative represented by formula I or II, the binder employing deionized water or an aqueous solution comprising 1 vol. % of acetic acid as a dispersant; 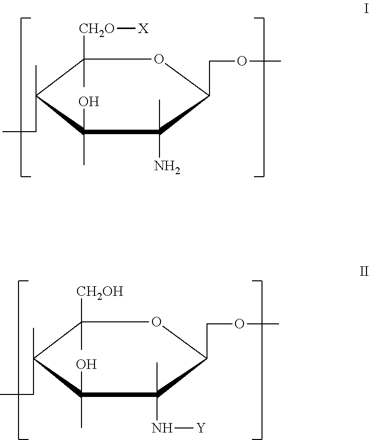
wherein, X of the formula I represents a hydrocarbon acyl, aromatic acyl, alkyl, or aryl, and Y of the formula II represents an alkane acyl or aryl.

2. The binder of claim 1, wherein the chitosan derivative represented by formula I or II has a viscosity of between 50 and 1000 cps.

3. A method for preparing an electrode of a lithium ion battery, the method comprising adding the binder of claim 1 to a conductive agent in the process of preparation.

4. The method of claim 3, wherein the electrode of the lithium ion battery comprises an active material, the conductive agent, and the binder, a mass percent thereof being 50-80:10-30:5-20; the binder comprises the chitosan derivative represented by formula I or II, and a dispersant of the binder is deionized water or an aqueous solution comprising 1 vol. % of acetic acid.
